(19) United States
(12) Patent Application Publication
(10) Pub. No.: US 2009/0276245 A1
(43) Pub. Date: Nov. 5, 2009

(54) AUTOMATED HEALTHCARE IMAGE REGISTRATION WORKFLOW

(75) Inventors: Balazs Peter Cziria, Pest megye (HU); Akos Erdos, Pest Megye (HU); Lehel M. Ferenczi, Budaors, Pest Megye (HU); Judit Kanyo, Budapest XIII (HU)

Correspondence Address: DEAN D. SMALL;THE SMALL PATENT LAW GROUP LLP, 225 S. MERAMEC, STE. 725T, ST. LOUIS, MO, 63105, US

(73) Assignee: GENERAL ELECTRIC COMPANY, Schenectady, NY (US)

(21) Appl. No.: 12/114,848

(22) Filed: May 5, 2008

(51) Int. Cl. G06Q 50/00

(52) U.S. Cl. 705/3

(57) ABSTRACT

Systems, methods and apparatus are provided through which in some implementations automatic selection of a number of options in a clinical scenario of healthcare image workflow is provided. The options include selection of datasets, registration process, display mode, fusing process and/or publication. The automatic selection provides for a fully automated workflow.

### FIELD

This invention relates generally to medical imaging, and more particularly to workflow of medical image registration.

### BACKGROUND

Healthcare image acquisition is performed in a variety of modalities such as magnetic resonance imaging (MRI), computed tomography (CT), ultrasound, positron emission tomography (PET) and hybrid of modalities such as PET/CT. In addition imaging can also be performed in two dimensions (2-D), three dimensions (3-D), and four dimensions (4-D).

Increasingly, the various modalities of healthcare imaging are being used together and intermingled for diagnosis. The various functions in a healthcare image workflow such as registration (correcting discrepancies in spatial correspondence between different datasets of healthcare images) are performed under direct supervision and control of a human operator.

### BRIEF DESCRIPTION

The above-mentioned shortcomings, disadvantages and problems are addressed herein, which will be understood by reading and studying the following specification.

In one aspect, automatic selection of options in a clinical scenario of healthcare image workflow is provided. The options include selection of datasets, registration method, display mode, fusing method and/or publication. The automatic selection provides for a fully automated workflow.

In another aspect, a method manages the general registration process of selecting the datasets to register, selecting and performing a means of the registration method and perform the registration method, selecting and performing a means of displaying the registration results to verify or guide the registration, selecting and performing a means to fuse the result, and/or selecting from the results, possibly fused datasets, to publishing the results. Each of the selecting actions is performed either a) automatically, using a heuristic to perform the selection, possibly inferring from the modality of the datasets, resolution from the datasets, the clinical scenario in which the user is working or any other available information at that point, possibly checking the selection and overriding manually, and/or each of the selecting actions is performed manually when no heuristic available.

In yet another aspect, a method of healthcare image registration workflow includes recognizing a scenario from information in the memory, selecting a reference dataset from a plurality of datasets in the memory based on the scenario, selecting a registration dataset from the plurality of datasets in the memory based on the scenario, selecting a registration method based on the scenario, the reference dataset and the registration dataset, registering the registration dataset in reference to the reference dataset, selecting a display mode for verification/guidance of the registered dataset, displaying the registered dataset in the selected display mode for verification/guidance, selecting a method of fusing the registered dataset, fusing the registration results using the selected fusing method, selecting either fused results, the registered dataset or resampled registered dataset for publication, and publishing the selected results.

In still another aspect, a system includes a processor, a storage device coupled to the processor including a dataset of images, and software apparatus operative on the processor including a selector of a display mode for verification/guidance of registration of registered dataset, a displayer of the registered dataset in the selected display mode, a fuser of the registered dataset, and a publisher of the fused dataset.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of an overview of a system to manage health-care image registration workflow;

FIG. 2 is a flowchart of a method of health-care image registration workflow, according to an implementation;

FIG. 3 is a flowchart of a method of selecting, according to an implementation;

FIG. 4 is a flowchart of a method to recognize a scenario, according to an implementation;

FIG. 5 is a flowchart of a method to select at least one dataset from a dataset collection, according to an implementation;

FIG. 6 is an image of the operation of a graphical user interface in presentation of a selection of registration methods, according to an implementation;

FIG. 7 is an image of the operation of a graphical user interface in presentation of display modes having a preselected display mode, according to an implementation;

FIG. 8 is an image of the operation of a graphical user interface in presentation of a first user-selected display mode, according to an implementation;

FIG. 9 is an image of the operation of a graphical user interface in presentation of a second user-selected display mode, according to an implementation;

FIG. 10 is a simplified diagram of an overview of a modified system configured to improve X-ray imaging operations;

FIG. 11 illustrates an example of a general computer environment useful in the context of the environment of FIG. 10, in accordance with an implementation.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into five sections. In the first section, a system level overview is described. In the second section, implementations of methods are described. In the third section, images of the operation of a graphical user interface are described. In the fourth section, hardware and operating environments in conjunction with which implementations may be practiced are described. In the fifth section, a conclusion of the detailed description is provided.

### System Level Overview

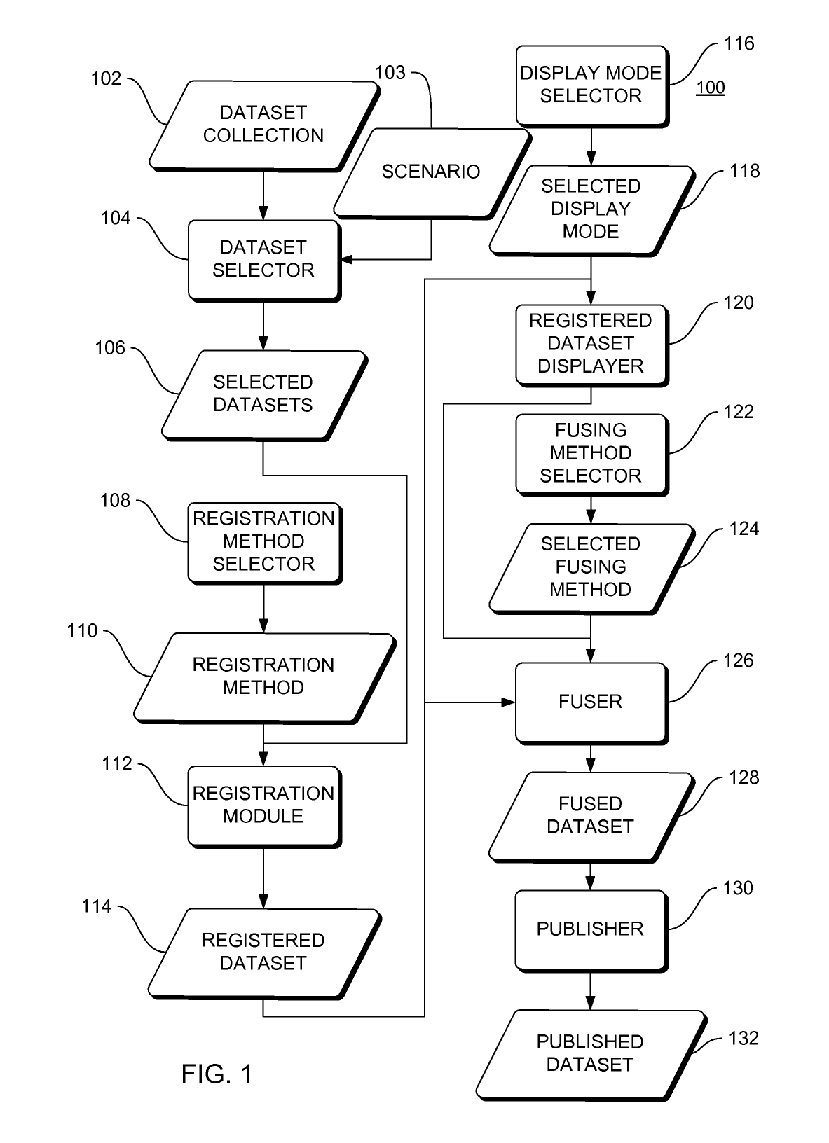

FIG. 1 is a block diagram of an overview of a system 100 to manage health-care image registration workflow. System 100 provides less user frustration and improved clinical throughput, by eliminating repeating steps, and exhibiting familiar behavior in different clinical scenarios, due to the reusable nature of this workflow component in which many applications can reuse this component, and system 100 also provides easier dealing in less frequent situation due to the pre-selections made by the heuristics.

Some implementations of system 100 include a health-care image dataset collection 102 and a scenario 103 that are received by a dataset selector 104. The dataset selector 104 is operable to select datasets 106 that includes a reference dataset and a registration dataset, based on, or in reference to the scenario 103. Scenarios in general are “clinical scenario” which describes a context in which physicians(s) perform a diagnosis, analysis or other steps, working with clinical data to produce a result. The clinical scenario describes steps, what data is the physician(s) working on, and how the steps are performed. For example, in a PET/CT follow up comparison, the image data is CT, PET AC, PET NAC exams from two different time points. The PET images are in the same geometrical position as the corresponding CT images, so no registration may be performed there. Registration happens between the two CT images and the registration is used to set the geometrical positions of the PET images as well. Rigid registration is sufficient in this example. After reading, usually no image series will be published as the result of the registration. A dataset is one or more images. A plurality of image is a three-dimensional (3D) (volumetric) or four-dimensional (4D) (volumetric) with time sampling) set of images of a patient acquired by a modality.

Some implementations of system 100 also include a registration method selector 108 that is operable to select a registration method 110. In some implementations the registration method selector 108 selects the registration method in reference to the scenario 103, the reference dataset and registration dataset in the selected datasets 106. Examples of registration methods 110 include CT-CT rigid registration targeted to Neuro oncology scenario, CT-CT rigid registration targeted to whole body follow-up scenario or CT-CT non-rigid registration targeted to whole body respiratory motion compensation or Landmark based rigid registration.

Some implementations of system 100 also including a registration module 112 that registers the registration dataset in reference to the reference dataset, yielding a registered dataset 114.

Some implementations of system 100 also include a display mode selector 116 that generates a selected display mode 118. System 100 also includes a registered dataset displayer 120 that displays the registered dataset and the reference dataset 106 in the selected display mode 116 for verification and guidance. During display, the datasets can be viewed and displayed using conventional controls, such as setting window levels, scrolling and/or zooming-in to closely review portions of the image.

Some implementations of system 100 also include a fusing method selector 122 that is operable to select a fusing method 124. A fuser 126 fuses the registered dataset 114 using the selected fusing method 124, resulting in a fused dataset 128. Fusing is combining multiple images into a single image.

Some implementations of system 100 also include a publisher 130 that is operable to publish 132 either the fused dataset 128 or the registered dataset.

The system 100 is not limited to any particular dataset collection 102, scenario 103, dataset selector 104, selected datasets 106, registration method selector 108, registration method 110, registration module 112, registered dataset 114, display mode selector 116, selected display mode 118, registered dataset display 120, fusing method selector 122, selected fusing method 124, fuser 126, fused dataset 128, publisher 130, and published results 132. For sake of clarity, a simplified dataset collection 102, scenario 103, dataset selector 104, selected datasets 106, registration method selector 108, registration method 110, registration module 112, registered dataset 114, display mode selector 116, selected display mode 118, registered dataset display 120, fusing method selector 122, selected fusing method 124, fuser 126, fused dataset 128, publisher 130, and published results 132 are described.

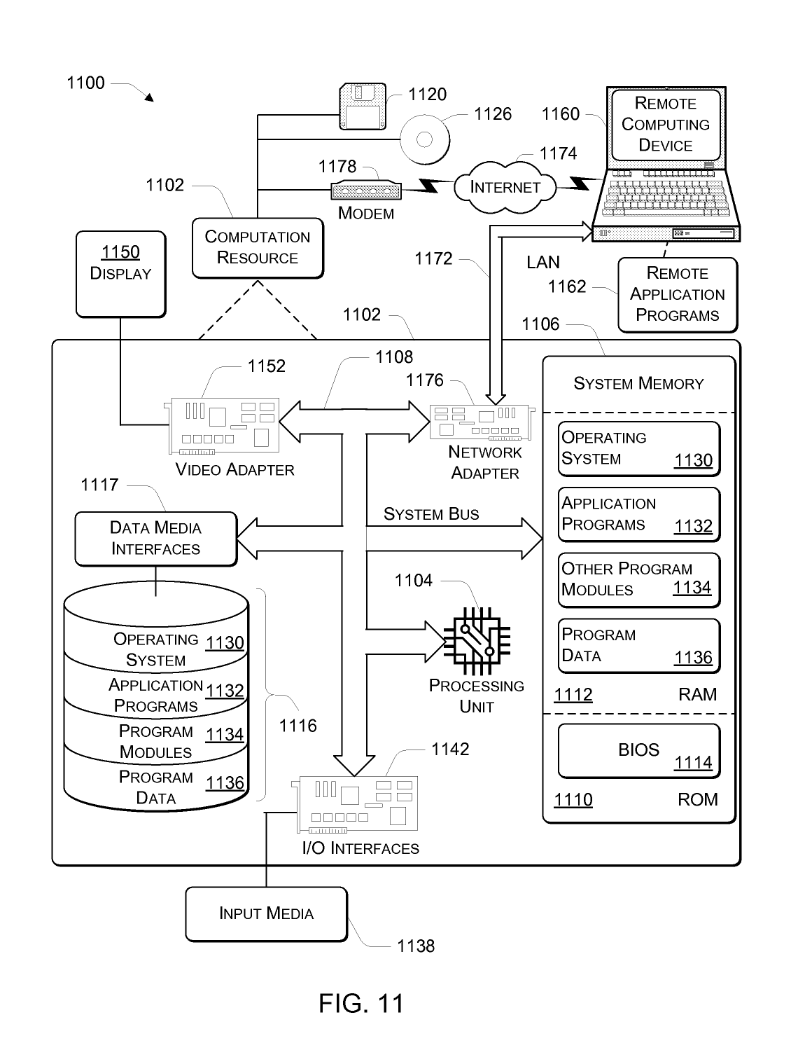

The system level overview of the operation of an implementation is described above in this section of the detailed description. Some implementations operate in a multi-processing, multi-threaded operating environment on a computer, such as general computer environment 1100 in FIG. 11.

### Method Implementations

In the previous section, a system level overview of the operation of an implementation is described. In this section, the particular methods of such an implementation are described by reference to a series of flowcharts. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions. Methods 200-500 are performed by a program executing on, or performed by firmware or hardware that is a part of, a computer, such as general computer environment 1100 in FIG. 11.

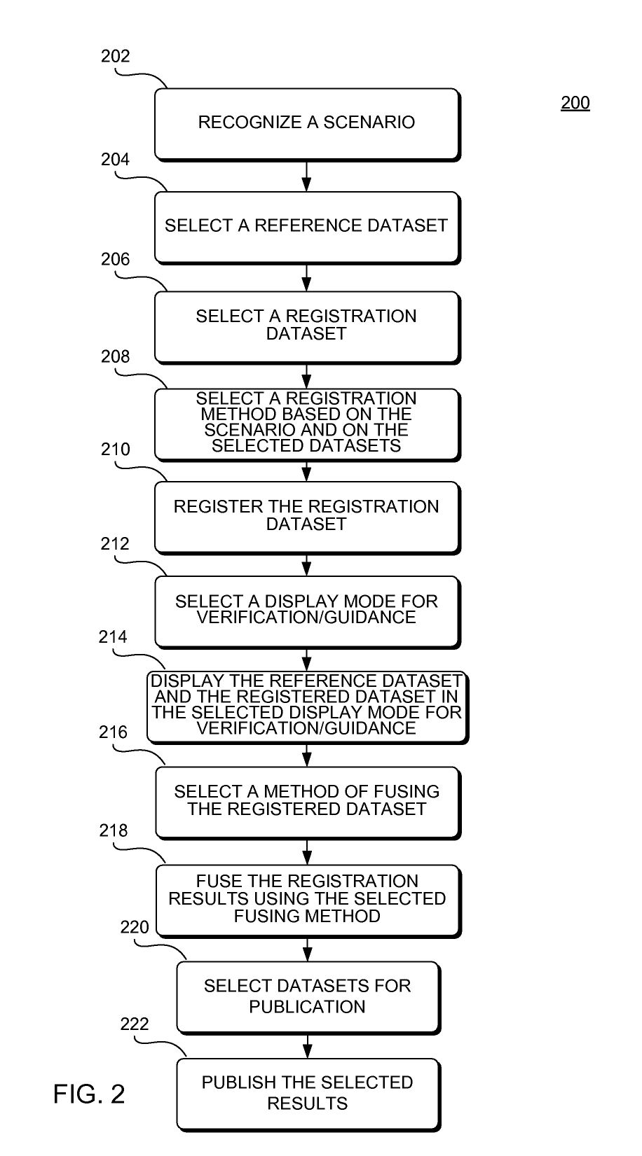

FIG. 2 is a flowchart of a method 200 of health-care image registration workflow, according to an implementation. In general, method 200 manages the general registration process of selecting the datasets to register, selecting and performing a means of the registration method and perform the registration method, selecting and performing a means of displaying the registration results to verify or guide the registration, selecting and performing a means to fuse the result, and/or selecting from the results, possibly fused datasets, to publishing the results.

Each of the selecting actions is performed either a) automatically, using a heuristic to perform the selection, possibly inferring from the modality of the datasets, resolution from the datasets, the clinical scenario in which the user is working or any other available information at that point, possibly checking the selection and overriding manually, and/or each of the selecting actions is performed manually when no heuristic available.

Each of the actions can be optional depending on the clinical scenario. Necessary information about the clinical scenario can be inferred automatically or selecting explicitly, e.g. by means of using named protocols. Thus, in most of the clinical imaging situations, the human clinical operator experiences an automatic workflow requiring no intervention apart from checking the result.

Some implementations of method 200 include recognizing a scenario or a use case from information in a memory, at block 202. The scenario is recognized from volume time point (exam date), modalities, the number of volumes, and the anatomy.

Some implementations of method 200 include selecting a reference dataset from a plurality of datasets, based on the scenario, at block 204.

Some implementations of method 200 include selecting a registration dataset from the plurality of datasets in the memory based on the scenario, at block 206.

Some implementations of method 200 include selecting a registration method based on the scenario, the reference dataset and the registration dataset, at block 208.

Some implementations of method 200 include registering the registration dataset in reference to the reference dataset, at block 210.

Some implementations of method 200 include selecting a display mode for verification/guidance of the registered dataset, at block 212. Examples of the display mode include a fused mode, tiled mode and a magnification glass mode.

Some implementations of method 200 include displaying the reference dataset and the registered dataset in the selected display mode for verification/guidance, at block 214.

Some implementations of method 200 include selecting a method or process of fusing the registered dataset, at block 216.

Some implementations of method 200 include fusing the registration results using the selected fusing method or process, at block 218.

Some implementations of method 200 include selecting either fused results, the registered dataset or resampled registered dataset for publication, at block 220.

Some implementations of method 200 include publishing the selected results, at block 222. The publishing function includes exporting or saving to a particular specified file format. Publication provides access to the results in other clinical scenarios and other clinical workflows.

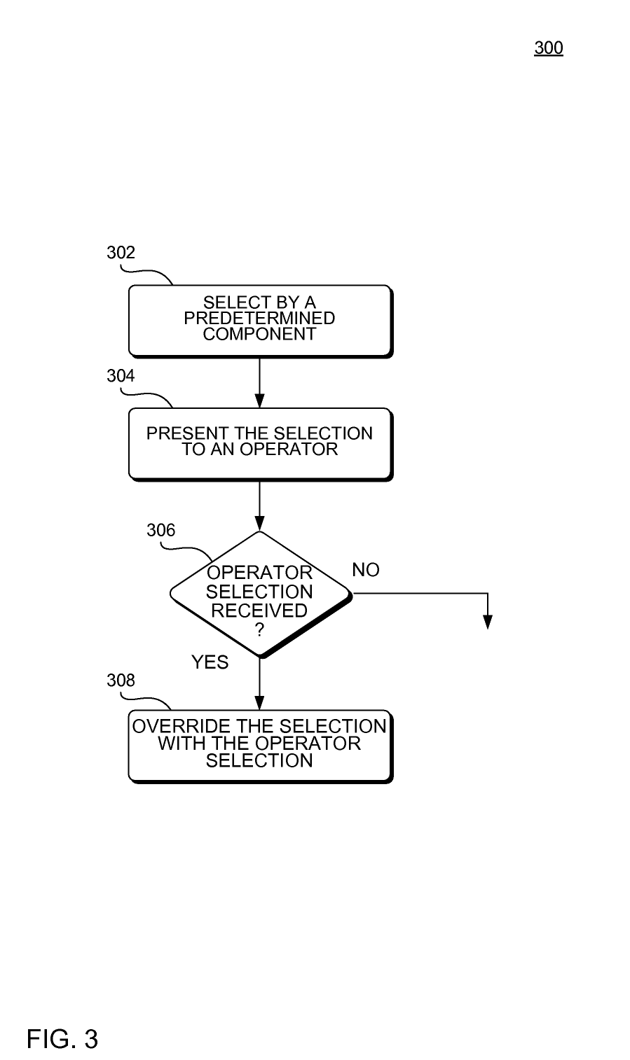

FIG. 3 is a flowchart of a method 300 of selecting, according to an implementation. Method 300 provides automatic selection of an option in a workflow of healthcare image registration that can be overridden by a user. Method 300 performs any of the selecting functions described in system 100 or method 200, such as selecting a reference dataset 204, selecting a registration dataset 206, selecting a registration method 208, selecting a display mode 212, selecting a method of fusing at 216, and selecting publication 220. The selecting of method of 300 is equally applicable to any of the selection functions described in system 100 or method 200.

Method 300 includes selecting performed by a predetermined component, at block 302. In the selecting 302, a component performs a selection process for the subject data, devoid and absent of any human interaction. For example, when method 300 is performed for selecting a display mode 212. The component using data and instructions without any intervention from human will perform the selecting of the display mode. The selecting a 302 provides an initial computer implemented selection from which a user will later in the method 300 have an opportunity to change or override.

In order to give a human user an opportunity to change or variety, the selection determined by the component, method 300 includes presenting the selection to an operator, at block 304. The selection that was determined or generated at block 302 is presented to the user for review presentation can be in any manner such as visual display on a graphical user interface. The presentation of the selection provides an opportunity for the user to enter an alternative selection.

Thereafter, method 300 includes determining whether or not, the operator provided an alternative selection, at block 306. If an alternative selection by the operator is determined to have been received at block 306, then the selection generated by the component at block 302 is overridden by the alternative selection provided by the operator, at block 308. If an alternative selection by the operator is not determined to have been received at block 306, then the selection determined by the component 302 is not overridden and the selection determined by the component about 302 will be used in subsequent processing.

Method 300 provides a computer generated selection that can be overridden by a user. Thus method 300 provides an efficient manner in which the best selection can be determined and provided for subsequent processing, for all aspects of the different options that a user might or could possibly be asked to determine. In this way, method 300 provides a means in which options can be quickly and easily decided with the added feature of computer assistance in suggesting or providing a selection.

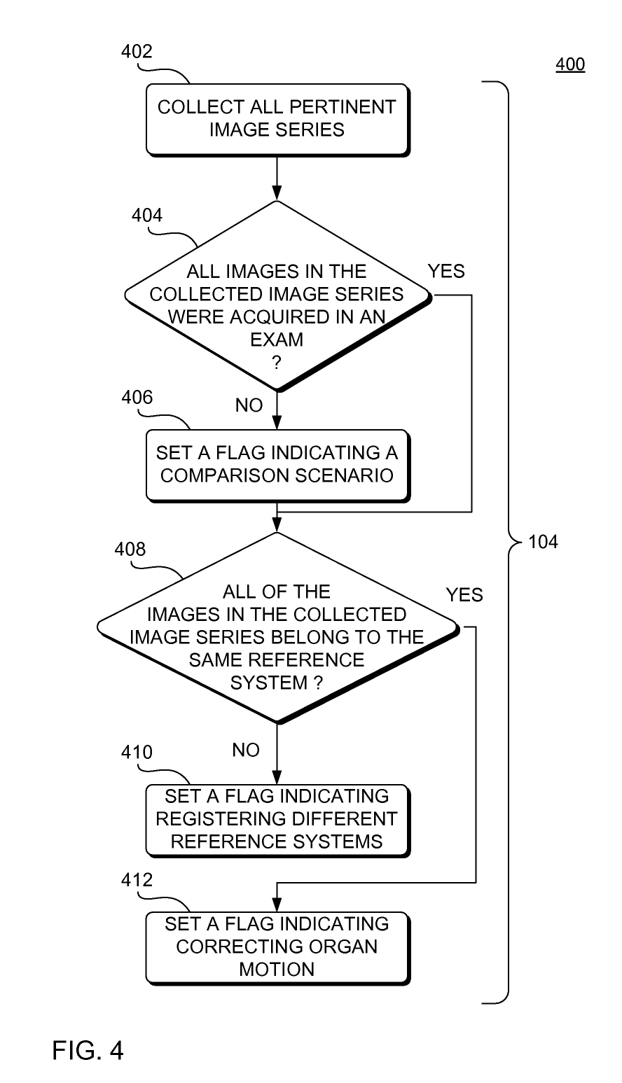

FIG. 4 is a flowchart of a method 400 to recognize a scenario, according to an implementation. Method 400 includes collecting and/or identifying all pertinent image series from the information, at block 402.

Method 400 also includes determining or verifying whether or not all images in the collected image series were acquired in an exam, at block 404. If not all images in the collected image series was acquired in one exam, then a flag is set indicating a comparison scenario when the verifying fails, at block 406. In some implementations, the verifying at block 404 includes verifying that all images in the collected image series were acquired at approximately the same time such that patient anatomy is negligibly apart from distortion due to movement of patient during image acquisition.

Method 400 also includes determining whether or not all of the images in the collected image series belong to the same coordinate reference system, at block 408. In some implementations, block 408 is not performed if all images in the collected image series are determined to have been acquired in an exam, at block 404. If all of the images in the collected image series are determined to not belong to the same reference system at block 408, then a flag indicating registration of different coordinate reference systems is set at block 410. In some implementations, the verifying at block 408 includes verifying that all images in the collected image series were acquired at approximately the same time such that patient anatomy is negligible apart from distortion due to movement of patient during image acquisition.

If all of the images in the collected image series are determined to belong to the same coordinate reference system, at block 408, then a flag indicating correction of organ motion is set at block 412.

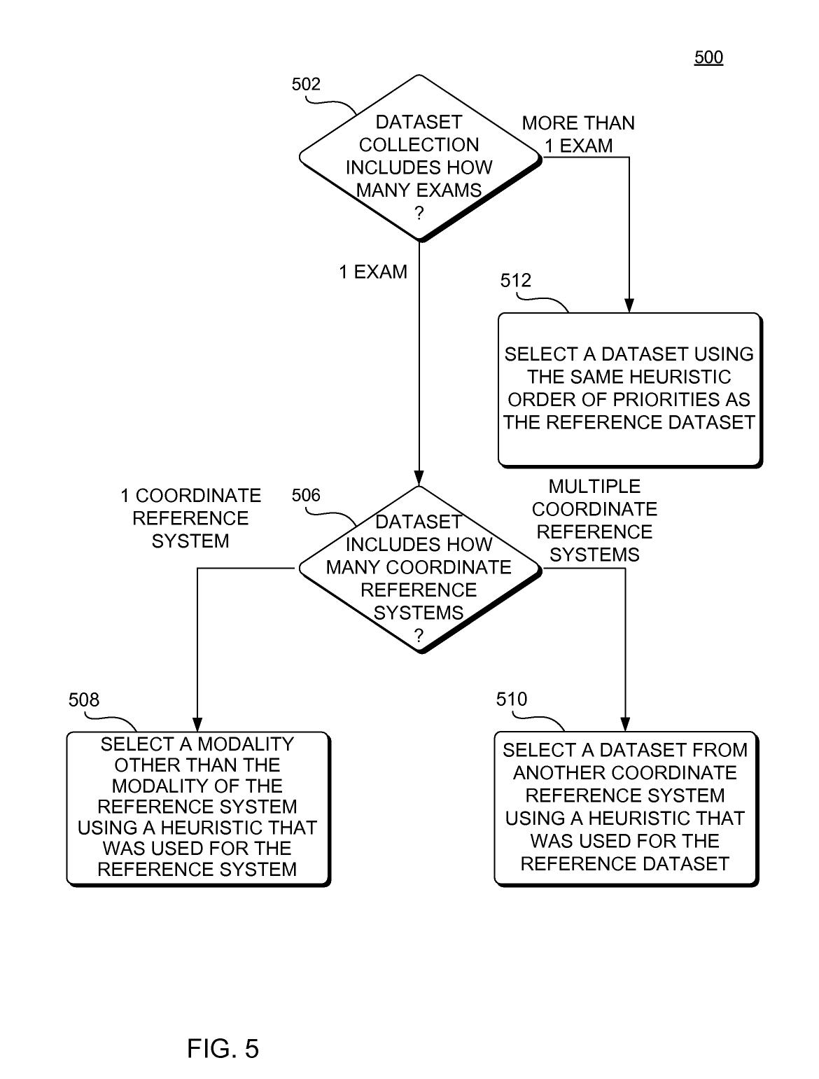

FIG. 5 is a flowchart of a method 500 to select at least one dataset from a dataset collection, according to an implementation. Method 500 includes determining how many exams are in a particular dataset collection, at block 502.

If one exam is determined to be in the dataset collection, then a determination of how many coordinate reference system are in the dataset is performed, at block 506. If one coordinate reference system is determined to be in the dataset at block 506 in one exam is determined to be in the dataset at block 502, then a modality other than the modality of the reference dataset is selected, at block 508. In some implementations, the selection at block 508 is performed using a heuristic that was used for the reference dataset, according to the heuristic order of priority of modalities, when the dataset collection includes only one exam and the one exam includes only one coordinate reference system. In some implementations the heuristic order of priority of modalities is as follows:
a computed tomography modality dataset;
a magnetic resonance modality dataset;
a positron emission tomography attenuation-corrected imaging dataset;
a single photon positron emission tomography imaging dataset;
a positron emission tomography non-attenuation-corrected imaging dataset;
an earliest dataset from an exam; and
an earliest dataset from a plurality of exams.

If multiple coordinate reference system are determined to be in the dataset at block 506 and one exam is determined to be in the dataset at block 502, then a dataset is selected from another coordinate reference system. In some implementations the dataset is selected using a heuristic that was used for the reference dataset, at block 510.

If more than one exam is determined to be in the dataset collection at block 502, then a dataset from another exam is selected, using the same heuristic order of priority of modalities as the reference dataset, at block 512.

In some implementations, methods 200-500 are implemented as a computer data signal embodied in a carrier wave, that represents a sequence of instructions which, when executed by a processor, such as processing units 1104 in FIG. 11, cause the processor to perform the respective method. In other implementations, methods 200-500 are implemented as a computer-accessible medium having executable instructions capable of directing a processor, such as processing units 1104 in FIG. 11, to perform the respective method. In varying implementations, the medium is a magnetic medium, an electronic medium, or an optical medium.

### Images of the Operation of a Graphical User Interface

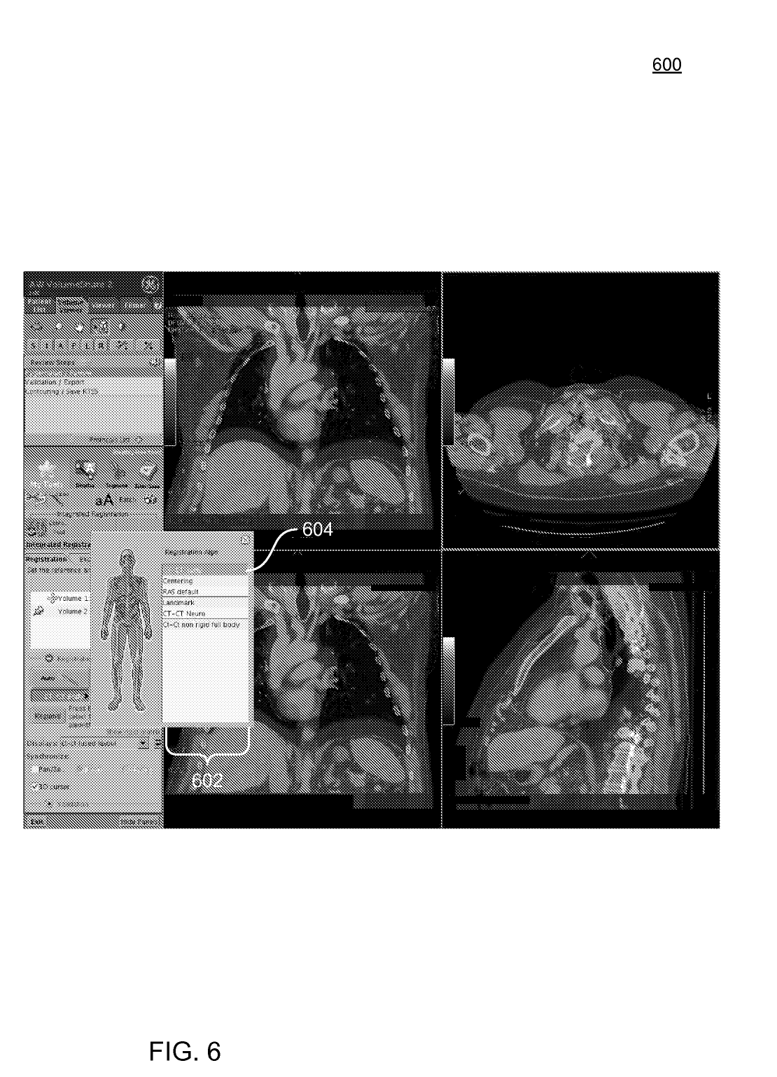

FIG. 6 is an image 600 of the operation of a graphical user interface in presentation of a selection of registration methods, according to an implementation. Image 600 shows a portion of a graphical display of a medical image workstation. The image 600 includes a pulldown menu 602 that presents a selection of registration methods. The pulldown menu 602 presents registration methods that include “CT-CT Neuro,” 604 “centering,” “RAS default,” “landmark,” “CT-CT body,” and “CT-CT non rigid full body.” In pull-down menu 602, the selection of registration method “CT-CT Neuro” is highlighted 604 as a result of a registration method selector, such as registration method selector 108 in FIG. 1, having generated a registration method. In some implementations, the selected registration method is selected by a component based on the scenario, a reference dataset and a registration dataset.

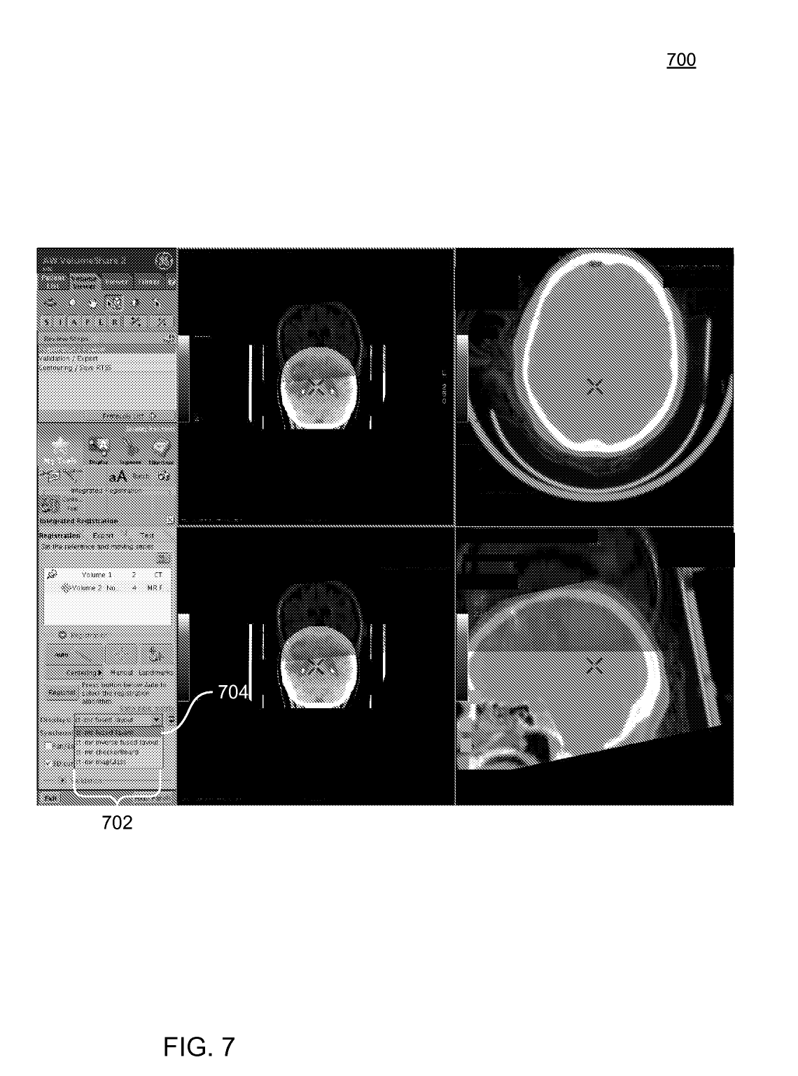

FIG. 7 is an image 700 of the operation of a graphical user interface in presentation of display modes having a preselected display mode, according to an implementation. Image 700 shows a portion of a graphical display of a medical image workstation. The image 700 includes a pulldown menu 702 that presents a selection of display modes or methods. In the example of image 700, the pulldown menu 702 presents display modes that include “CT-MR fused layout,” “CT-MR inverse fused layout,” “CT-MR checkboard,” “CT-MR,” and “CT-MR magGlass.” In pull-down menu 702, the selection of display mode “CT-MR fused layout” 704 is highlighted as a result of a display mode selector, such as registration method selector 116 in FIG. 1, having generated a display mode 118. The display mode 118 is presented in the pulldown menu 702 as the highlighted selection 704 of the selection of display modes.

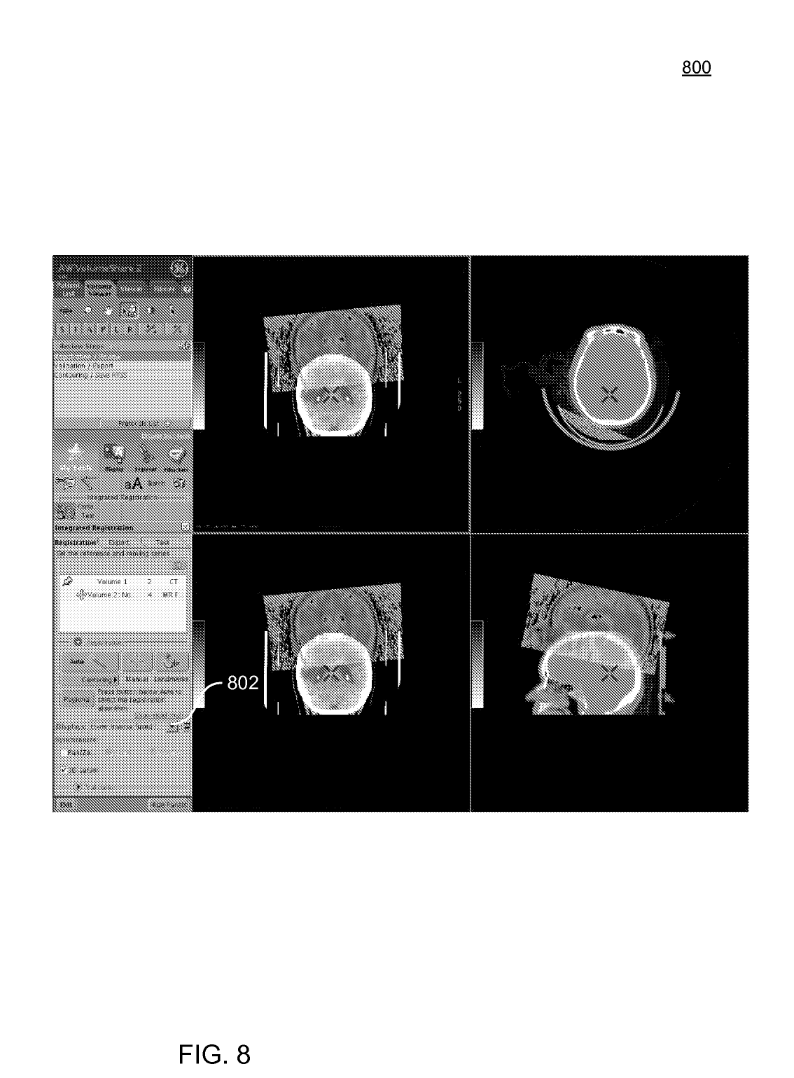

FIG. 8 is an image 800 of the operation of a graphical user interface in presentation of a first user-selected display mode, according to an implementation. Image 800 shows a selected display mode of “CT-MR inverse fused layout” 802.

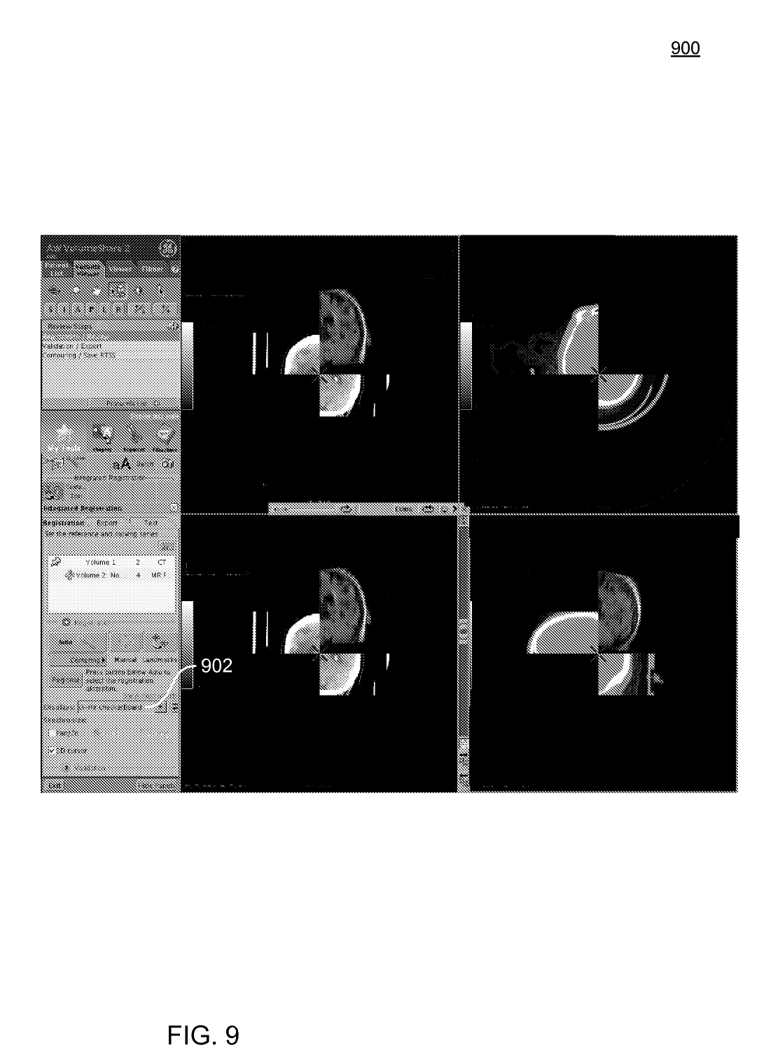

FIG. 9 is an image 900 of the operation of a graphical user interface in presentation of a second user-selected display mode, according to an implementation. Image 900 shows a selected display mode of “CT-MR checkboard” 902.

### Hardware and Operating Environment

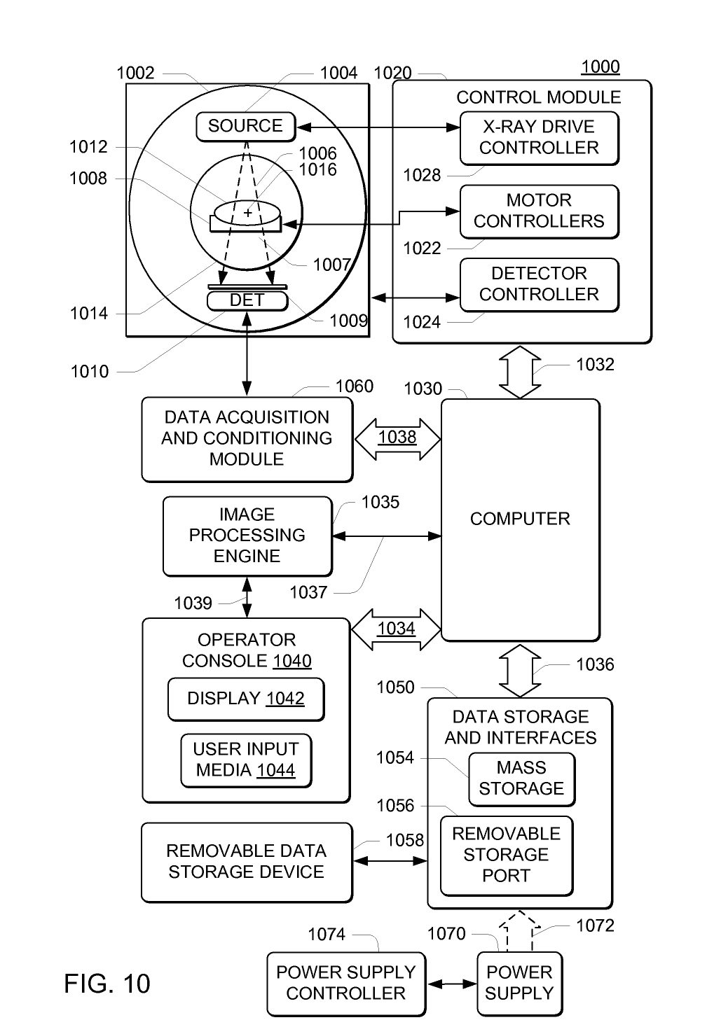

FIG. 10 is a simplified diagram of an overview of a modified system 1000 configured to improve X-ray imaging operations. The system 1000 optionally includes a gantry 1002 or other support for an illumination source 1004, such as an X-ray illumination source, capable of providing illumination 1006, such as X-rays or other non-destructive internal imaging illumination, and can optionally include a test subject support 1008 that is transmissive with respect to the illumination 1006 and that is positioned above a scintillator 1009 and detector 1010 that is also opposed to the illumination source 1004. Alternatively, a direct conversion detector 1010 can be employed without need for a scintillator.

In one implementation, components of the system 1000 and a test subject 1012 are maintained in a defined geometric relationship to one another by the gantry 1002. A distance between the illumination source 1004 and the detector 1010 can be varied, depending on the type of examination sought, and the angle of the illumination 1006 respective to the test subject 1012 can be adjusted with respect to the body to be imaged responsive to the nature of imaging desired.

In one implementation, the test subject support 1008 is configured to support and/or cause controlled motion of the test subject 1012, such as a living human or animal patient, or other test subject 1012 suitable for non-destructive imaging, above the scintillator 1009/detector 1010 so that illumination 1007 is incident thereon after passing through the test subject 1012. In turn, information from the detector array 1010 describes internal aspects of the test subject 1012.

The scintillator 1009 can be a conventional CsI scintillator 1009, optically coupled to an array of photodiodes (not illustrated), such as a two-dimensional array of photodiodes and suitable control transistors formed using semiconductor material such as amorphous silicon, or any other form of detector 1010 suitable for use with the type or types of illumination 1006 being employed, such as X-rays. The detector elements are typically tesselated in a mosaic. The scintillator 1009 converts incident photons comprising electromagnetic radiation, such as X-rays, from high-energy, high-frequency photons 1007, into lower-energy, lower-frequency photons corresponding to spectral sensitivity of the detector elements, in a fashion somewhat analogous to fluorescence, as is commonly known in the context of many visible-light sources in use today. Alternatively, the detector 1010 can be formed as a flat-panel array including amorphous Silicon (α-Si) active elements, together with either a scintillator layer 1009, or a direct converter material such as Cadmium Zinc Telluride (CdZnTe), Mercuric Iodide (HgI₂), Lead Iodide (PbI₂), or amorphous Selenium (α-Se).

In some modes of operation, such as CT, the gantry 1002 and test subject support or table 1008 cooperatively engage to move the test subject 1012 longitudinally within an opening 1014, that is, along an axis 1016 extending into and out of the plane of FIG. 10. In some modes of operation, the gantry 1002 rotates the X-ray source 1004 and detector 1010 about the axis 1016, while the support 1008 moves longitudinally, to provide a helical series of scans of the test subject 1012, where a pitch of the helices is defined as a ratio of a longitudinal distance traveled by the table 1008 during a complete revolution of the gantry 1002, compared to a length of the detector 1010 along the axis 1016 of linear motion.

The system 1000 also optionally includes a control module or controller 1020. The controller 1020 can include a motor control module 1022 configured to move the test subject support 1008 and thus the test subject 1012 relative to the X-ray source 1004 and/or detector 1010, and can also control motors in the gantry 1002 or to position the X-ray illumination source 1004 relative to the test subject 1012 and/or the detector 1010.

The controller 1020 includes a detector controller 1024 configured to control elements within the detector 1010 and to facilitate data transfer therefrom. The controller 1020 also includes a drive parameter controller 1028 configured to control electrical drive parameters delivered to the X-ray source 1004. One or more computers 1030 provide connections to the controller 1020 via a bus 1032 configured for receiving data descriptive of operating conditions and configurations and for supplying appropriate control signals. Buses 1034, 1037 and 1039 act to transfer data and control signals, for example with respect to a module 1035, configured as an image processing engine, via interconnections such as 1037, 1039 that are configured for exchange of signals and data to and/or from the computer 1030 as well as other elements of the system 1000 and/or external computation or communications resources (not illustrated in FIG. 10).

The system 1000 also includes a bus 1036, a bus 1038 and an operator console 1040. The operator console 1040 is coupled to the system 1000 through the bus 1034. The operator console 1040 includes one or more displays 1042 and a user input interface 1044. The user input interface 1044 can include a touchscreen, keyboard, a mouse or other tactile input device, capability for voice commands and/or other input devices. The one or more displays 1042 provide video, symbolic and/or audio information relative to operation of system 1000, user-selectable options and images descriptive of the test subject 1012, and can display a graphical user interface for facilitating user selection among various modes of operation and other system settings.

The image processing engine 1035 facilitates automation of accurate measurement and assessment. The image processing engine 1035 is capable of forming multiple, coordinated images for display, for example via the monitor 1042, to provide the types of depictions described below. The image processing engine 1035 can comprise a separate and distinct module, which can include application-specific integrated circuitry, or can comprise one or more processors coupled with suitable computer-readable program modules, or can comprise a portion of the computer 1030 or other computation device.

The system 1000 also includes memory devices 1050, coupled via the bus 1036 to the computer 1030 through suitable interfaces. Datasets representing three-dimensional data and image or two-dimensional data typically conform to the digital imaging and communications in medicine (DICOM) standard, which is widely adopted for handling, storing, printing, and transmitting information in medical imaging. The DICOM standard includes a file format definition and a network communications protocol. The communication protocol is an application protocol that uses TCP/IP to communicate between systems. DICOM files can be stored in memory devices 1050 and retrieved therefrom, and can be exchanged between two entities that are capable of receiving image and patient data in DICOM format.

The memory devices 1050 include mass data storage capabilities 1054 and one or more removable data storage device ports 1056. The one or more removable data storage device ports 1056 are adapted to detachably couple to portable data memories 1058, which can include optical, magnetic and/or semiconductor memories and can have read and/or write capabilities, and which can be volatile or non-volatile devices or can include a combination of the preceding capabilities.

The system 1000 further includes a data acquisition and conditioning module 1060 that has data inputs coupled to the detector 1010 and that is coupled by the bus 1038 to the one or more computers 1030. The data acquisition and conditioning module 1060 includes analog to digital conversion circuitry for capturing analog data from the detector 1010 and then converting those data from the detector 1010 into digital form, to be supplied to the one or more computers 1030 for ultimate display via at least one of the displays 1042 and for potential storage in the mass storage device 1054 and/or data exchange with remote facilities (not shown in FIG. 10). The acquired image data can be conditioned in either the data acquisition and conditioning module 1060 or the one or more computers 1030 or both.

The system 1000 also includes a power supply 1070, coupled via interconnections represented as a power supply bus 1072, shown in dashed outline, to other system elements, and a power supply controller 1074. In some implementations, the system 1000 is configured to be a mobile system equipped with a portable power supply 1070, such as a battery. In other words, the system 1000 can comprise a wheeled unit and can be electromotively powered in self-contained fashion, lending physical agility to the ensemble of attributes offered by the system 1000.

Volumetric data collected via exposure of the test subject 1012 to suitable illumination 1006 can be processed via many different types of tools, each intended to enhance some portion of information content described by the data. One result can be inconsistency between analytical results from different types of signal processing tools, or between measurement results corresponding to different measurement times and/or measurement phases.

FIG. 10 is a block diagram of a hardware and operating environment 1000 in which different implementations can be practiced. The description of FIG. 10 provides an overview of computer hardware and a suitable computing environment in conjunction with which some implementations can be implemented. Implementations are described in terms of a computer executing computer-executable instructions. However, some implementations can be implemented entirely in computer hardware in which the computer-executable instructions are implemented in read-only memory. Some implementations can also be implemented in client/server computing environments where remote devices that perform tasks are linked through a communications network. Program modules can be located in both local and remote memory storage devices in a distributed computing environment.

FIG. 11 illustrates an example of a general computer environment 1100 useful in the context of the environment of FIG. 10, in accordance with an implementation. The general computer environment 1100 includes a computation resource 1102 capable of implementing the processes described herein. It will be appreciated that other devices can alternatively used that include more components, or in fewer components, than those illustrated in FIG. 11.

The illustrated operating environment 1100 is only one example of a suitable operating environment, and the example described with reference to FIG. 11 is not intended to suggest any limitation as to the scope of use or functionality of the implementations of this disclosure. Other well-known computing systems, environments, and/or configurations can be suitable for implementation and/or application of the subject matter disclosed herein.

The computation resource 1102 includes one or more processors or processing units 1104, a system memory 1106, and a bus 1108 that couples various system components including the system memory 1106 to processor(s) 1104 and other elements in the environment 1100. The bus 1108 represents one or more of any of several types of bus structures, including a memory bus or memory controller, a peripheral bus, an accelerated graphics port and a processor or local bus using any of a variety of bus architectures, and can be compatible with SCSI (small computer system interconnect), or other conventional bus architectures and protocols.

The system memory 1106 includes nonvolatile read-only memory (ROM) 1110 and random access memory (RAM) 1112, which can or can not include volatile memory elements. A basic input/output system (BIOS) 1114, containing the elementary routines that help to transfer information between elements within computation resource 1102 and with external items, typically invoked into operating memory during start-up, is stored in ROM 1110.

The computation resource 1102 further can include a non-volatile read/write memory 1116, represented in FIG. 11 as a hard disk drive, coupled to bus 1108 via a data media interface 1117 (e.g., a SCSI, ATA, or other type of interface); a magnetic disk drive (not shown) for reading from, and/or writing to, a removable magnetic disk 1120 and an optical disk drive (not shown) for reading from, and/or writing to, a removable optical disk 1126 such as a CD, DVD, or other optical media.

The non-volatile read/write memory 1116 and associated computer-readable media provide nonvolatile storage of computer-readable instructions, data structures, program modules and other data for the computation resource 1102. Although the exemplary environment 1100 is described herein as employing a non-volatile read/write memory 1116, a removable magnetic disk 1120 and a removable optical disk 1126, it will be appreciated by those skilled in the art that other types of computer-readable media which can store data that is accessible by a computer, such as magnetic cassettes, FLASH memory cards, random access memories (RAMs), read only memories (ROM), and the like, can also be used in the exemplary operating environment.

A number of program modules can be stored via the non-volatile read/write memory 1116, magnetic disk 1120, optical disk 1126, ROM 1110, or RAM 1112, including an operating system 1130, one or more application programs 1132, other program modules 1134 and program data 1136. Examples of computer operating systems conventionally employed for some types of three-dimensional and/or two-dimensional medical image data include the NUCLEUS® operating system, the LINUX® operating system, and others, for example, providing capability for supporting application programs 1132 using, for example, code modules written in the C++® computer programming language.

A user can enter commands and information into computation resource 1102 through input devices such as input media 1138 (e.g., keyboard/keypad, tactile input or pointing device, mouse, foot-operated switching apparatus, joystick, touchscreen or touchpad, microphone, antenna etc.). Such input devices 1138 are coupled to the processing unit 1104 through a conventional input/output interface 1142 that is, in turn, coupled to the system bus. A monitor 1150 or other type of display device is also coupled to the system bus 1108 via an interface, such as a video adapter 1152.

The computation resource 1102 can include capability for operating in a networked environment (as illustrated in FIG. 10, for example) using logical connections to one or more remote computers, such as a remote computer 1160. The remote computer 1160 can be a personal computer, a server, a router, a network PC, a peer device or other common network node, and typically includes many or all of the elements described above relative to the computation resource 1102. In a networked environment, program modules depicted relative to the computation resource 1102, or portions thereof, can be stored in a remote memory storage device such as can be associated with the remote computer 1160. By way of example, remote application programs 1162 reside on a memory device of the remote computer 1160. The logical connections represented in FIG. 11 can include interface capabilities, e.g., such as interface capabilities 1052 (FIG. 10) a storage area network (SAN, not illustrated in FIG. 11), local area network (LAN) 1172 and/or a wide area network (WAN) 1174, but can also include other networks.

Such networking environments are commonplace in modern computer systems, and in association with intranets and the Internet. In certain implementations, the computation resource 1102 executes an Internet Web browser program (which can optionally be integrated into the operating system 1130), such as the “Internet Explorer®” Web browser manufactured and distributed by the Microsoft Corporation of Redmond, Wash.

When used in a LAN-coupled environment, the computation resource 1102 communicates with or through the local area network 1172 via a network interface or adapter 1176. When used in a WAN-coupled environment, the computation resource 1102 typically includes interfaces, such as a modem 1178, or other apparatus, for establishing communications with or through the WAN 1174, such as the Internet. The modem 1178, which can be internal or external, is coupled to the system bus 1108 via a serial port interface.

In a networked environment, program modules depicted relative to the computation resource 1102, or portions thereof, can be stored in remote memory apparatus. It will be appreciated that the network connections shown are exemplary, and other means of establishing a communications link between various computer systems and elements can be used.

A user of a computer can operate in a networked environment 1000 using logical connections to one or more remote computers, such as a remote computer 1160, which can be a personal computer, a server, a router, a network PC, a peer device or other common network node. Typically, a remote computer 1160 includes many or all of the elements described above relative to the computer 1100 of FIG. 11.

The computation resource 1102 typically includes at least some form of computer-readable media. Computer-readable media can be any available media that can be accessed by the computation resource 1102. By way of example, and not limitation, computer-readable media can comprise computer storage media and communication media.

Computer storage media include volatile and nonvolatile, removable and non-removable media, implemented in any method or technology for storage of information, such as computer-readable instructions, data structures, program modules or other data. The term “computer storage media” includes, but is not limited to, RAM, ROM, EEPROM, FLASH memory or other memory technology, CD, DVD, or other optical storage, magnetic cassettes, magnetic tape, magnetic disk storage or other magnetic storage devices, or any other media which can be used to store computer-intelligible information and which can be accessed by the computation resource 1102.

Communication media typically embodies computer-readable instructions, data structures, program modules or other data, represented via, and determinable from, a modulated data signal, such as a carrier wave or other transport mechanism, and includes any information delivery media. The term “modulated data signal” means a signal that has one or more of its characteristics set or changed in such a manner as to encode information in the signal in a fashion amenable to computer interpretation.

By way of example, and not limitation, communication media include wired media, such as wired network or direct-wired connections, and wireless media, such as acoustic, RF, infrared and other wireless media. The scope of the term computer-readable media includes combinations of any of the above.

The computer 1102 can function as one or more of the control segments of module 1020 (FIG. 10), the computer 1030, the operator console 1040 and/or the data acquisition and conditioning module 1060, for example, via implementation of the processes in FIGS. 200-500, respectively, as one or more computer program modules.

Apparatus components of the system 100 and methods 200-500 can be embodied as computer hardware circuitry or as a computer-readable program, or a combination of both. In another implementation, system 100 and methods 200-500 are implemented in an application service provider (ASP) system.

More specifically, in the computer-readable program implementation, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in general computer environment 1100 in FIG. 11, or on at least as many computers as there are components.

### Conclusion

An automated healthcare image registration workflow system is described. A technical effect of the systems, methods and apparatus described herein is automated healthcare image registration workflow. Although specific implementations have been illustrated and described herein, it will be appreciated by those of ordinary skill in the art that any arrangement which is calculated to achieve the same purpose may be substituted for the specific implementations shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future communication devices, different file systems, and new data types.

The terminology used in this application is meant to include all imaging, object-oriented, and database environments and alternate technologies which provide the same functionality as described herein.

We claim:

1. A method of healthcare image registration workflow, the method comprising:
recognizing a scenario from information in the memory;
selecting a reference dataset from a plurality of datasets in the memory based on the scenario;
selecting a registration dataset from the plurality of datasets in the memory based on the scenario;
selecting a registration process based on the scenario, the reference dataset and the registration dataset;
registering the registration dataset in reference to the reference dataset;
selecting a display mode for verification/guidance; and
displaying the reference dataset and the registered dataset in the selected display mode for verification/guidance.

2. The method of claim 1, wherein the selecting further comprises:
selecting performed by a predetermined component;
presenting the selection to an operator; and
overriding the selection with a selection by the operator when the selection by the operator is received from the operator.

3. The method of claim 1, wherein recognizing a scenario further comprises:
collecting all pertinent image series from the information;
attempting to verify that all images in the collected image series were acquired in an exam;
setting a flag indicating a comparison scenario when the verifying fails;
attempting to verify that all of the images in the collected image series belong to the same reference system, if the flag indicating the comparison scenario is not set;
setting a flag indicating non-linear registration when the verifying succeeds; and
setting a flag indicating registering different reference systems when the verifying fails.

4. The method of claim 3, wherein the verifying further comprises:
verifying that all images in the collected image series were acquired at approximately the same time in that patient anatomy is negligible apart from distortion due to movement of patient during image acquisition.

5. The method of claim 1, wherein selecting the reference dataset further comprises:
selecting a dataset in the following heuristic order of priority of modalities:
a computed tomography modality dataset;
a magnetic resonance modality dataset;
a positron emission tomography attenuation-corrected imaging dataset;
a single photon positron emission tomography imaging dataset;
a positron emission tomography non-attenuation-corrected imaging dataset;
an earliest dataset from an exam; and
an earliest dataset from a plurality of exams.

6. The method of claim 5, wherein selecting the registration dataset from a dataset collection further comprises:
selecting a dataset with another modality the reference dataset, using a heuristic order of modalities, that was used for the reference dataset, when the dataset collection includes only one exam and only one coordinate reference system is present; and
selecting a dataset with another coordinate reference system than the one used for the reference dataset, using a heuristic order of modalities, that was used for the reference dataset, when the dataset collection includes only one exam but more than one coordinate reference system; and
selecting a dataset from another exam, using the same heuristic order of priority of modalities as the reference dataset, when the dataset collection includes more than one exam.

7. The method of claim 1, wherein the method further comprises:
selecting a method of fusing the registered dataset; and
fusing the registration results using the selected fusing method.

8. The method of claim 1, wherein the method further comprises:
selecting datasets for publication, from either fused results, the registered dataset or resampled registered dataset or any combination; and
publishing the selected results.

9. A computer-accessible medium having executable instructions capable of directing a processor to perform:
recognizing a scenario;
selecting a reference dataset and a registration dataset based on the scenario;
registering the registration dataset in reference to the reference dataset;
selecting a display mode for verification/guidance;
displaying the reference dataset and the registered dataset in the selected display mode for verification/guidance.
fusing the registration results; and
publishing the results.

10. The computer-accessible medium of claim 10, wherein the executable instructions capable of directing the processor to publish fused results further comprise executable instructions capable of directing the processor to perform:
selecting a process of fusing the registration results;
selecting results for publication; and
publishing the selected results.

11. The computer-accessible medium of claim 10, the executable instructions further comprise:
selecting the registration process based on the scenarios and the at least on selected at dataset.

12. The computer-accessible medium of claim 10, wherein the executable instructions capable of directing the processor to recognize the scenario further comprise executable instructions capable of directing the processor to perform:
collecting all pertinent image series;
attempting to verify that all images in the collected image series were acquired in an exam;
setting a flag indicating a comparison scenario when the verifying fails;
attempting to verify that all of the images in the collected image series belong to the same reference system, if the flag indicating the comparison scenario is not set;
setting a flag indicating correcting organ motion when the verifying succeeds; and
setting a flag indicating registering different reference systems when the verifying fails.

13. The computer-accessible medium of claim 10, wherein the executable instructions capable of directing the processor to verify further comprise executable instructions capable of directing the processor to perform:
verifying that all images in the collected image series were acquired at approximately the same time in that patient anatomy is neglible apart from distortion due to movement of patient during image acquisition.

14. The computer-accessible medium of claim 10, wherein the executable instructions capable of directing the processor to select the reference dataset further comprise executable instructions capable of directing the processor to perform:
selecting a dataset in the following heuristic order of priority of modalities:
a computed tomography modality dataset;
a magnetic resonance modality dataset;
a positron emission tomography attenuation-corrected imaging dataset;
a single photon positron emission tomography imaging dataset; and
a positron emission tomography non-attenuation-corrected imaging dataset.

15. The computer-accessible medium of claim 15, wherein the executable instructions capable of directing the processor to select a dataset from a dataset collection further comprise executable instructions capable of directing the processor to perform:
selecting a dataset with another modality the reference dataset, using a heuristic order of modalities, that was used for the reference dataset, when the dataset collection includes only one exam and only one coordinate reference system is present; and
selecting a dataset with another DICOM frame of reference system than the one used for the reference dataset, using a heuristic order of modalities, that was used for the reference dataset, when the dataset collection includes only one exam; and
selecting a dataset having in another exam, using the same heuristic order of priority of modalities as the reference dataset, when the dataset collection includes more than one exam.

16. A system comprising:
a processor;
a storage device coupled to the processor including a dataset of images; and
software apparatus operative on the processor comprising:
a selector of a display mode for verification/guidance of registration of registered dataset;
a displayer of the registered dataset in the selected display mode;
a fuser of the registered dataset; and
a publisher.

17. The system of claim 17, wherein the display mode further comprises:
fused mode;
tiled mode; and
magnification glass mode.

18. The system of claim 17, wherein the selector further comprises:
a selector component to generate a display mode selection;
a selection-presentation component operable to present the display mode selection to the operator and operable to receive and then transmit the operator selected display mode; and
a selection-overrider operable to received the operator selected display mode and operable to override the display mode selection with the operator selected display mode.

19. The system of claim 17, wherein the publisher further comprises:
a selector of results for publication;
a selector of a process of fusing the registration results; and
a fuser of the selected registration results using the selected fusing process.

20. A system comprising:
a processor;
a storage device coupled to the processor including a dataset of images; and
software apparatus operative on the processor comprising:
a selector of an plurality of options the options comprising a registration process, a display mode, and a fusing process, each option having a plurality of alternatives,
a registration module of a selected dataset using a selected registration process;
a displayer of a registered dataset in a selected display mode that is operable to transit a selected registered dataset;
a fuser of the selected registered dataset using the selected fusing process; and
a publisher.

21. The system of claim 21, wherein the selector further comprises:
a selector component to generate a selection of the one of the options;
a selection-presentation component operable to present the selected option and the plurality of alternatives of the option to an operator, and operable to receive and then transmit an operator selected option; and
a selection-overrider operable to receive the operator selected option and operable to override the selected option with the operator selected option.
